(19) United States
(12) Patent Application Publication
(10) Pub. No.: US 2017/0196348 A1
(43) Pub. Date: Jul. 13, 2017

(54) DEVICE HOLDER

(71) Applicant: Matthew Salzmann, Monona, WI (US)

(72) Inventor: Matthew Salzmann, Monona, WI (US)

(21) Appl. No.: 14/993,417

(22) Filed: Jan. 12, 2016

(51) Int. Cl. A45F 5/02; A45C 13/10; H04B 1/3827; A45C 11/00

(52) U.S. Cl. CPC A45F 5/021; A45C 11/00; A45C 13/1069; H04B 1/385; A45C 2011/002; A45F 2005/025; H04B 2001/3855

(57) ABSTRACT

An apparatus having a device holder being configured to attach to a horizontal member, wherein said device holder includes a back panel, a rim being configured to fit the device and held against the back panel and an attachment member connected to a rear portion of the device holder, the attachment member including an opening through which the horizontal member may pass, and wherein the opening is operable to enable the device holder to pivot around the horizontal member.

### CROSS-REFERENCE TO RELATED APPLICATIONS

Not applicable.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### FIELD OF THE INVENTION

One or more embodiments of the invention generally relate to mobile device accessories. More particularly, the invention relates to a mobile device holder that may be mounted to a buckle.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon. It is believed that some people may want means for quickly and easily storing a mobile phone or other mobile devices in a safe fashion that may enable the person to use the mobile device while in storage. The usage of the mobile device may include, without limitation, displaying and broadcasting information, inputting information, transmitting and receiving calls, etc. It is also believed that some users may wish to cover or hide the screen of the mobile device while in storage.

By way of educational background, an aspect of the prior art generally useful to be aware of is that there are currently some means for storing a mobile device available. Some of these means may be configured to be mounted to the belt of a user. Such approaches may require a flat buckle for mounting and may not include means for attaching to other types of buckles such as, but not limited to, frame and prong style buckles. Many of these means may not enable the mobile device to be used effectively while in storage. Some of these means may be configured for use with a specific mobile device or may be an integral part of a mobile device and may not enable a user to use the mobile device they already have. Some of these means may be configured for used with a specific type of belt or buckle or even an individual belt or buckle.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A through 1D illustrate an exemplary mobile device holder attached to a belt buckle, in accordance with an embodiment of the present invention. FIG. 1A is a diagrammatic front view. FIG. 1B is a diagrammatic top view. FIG. 1C is a diagrammatic side view, and FIG. 1D is a diagrammatic side view with the holder in a tilted position;

FIG. 2A is a diagrammatic side view of an exemplary mobile device holder attached to a frame and prong style belt buckle by a removable clip, in accordance with an embodiment of the present invention. FIG. 2B is a pictorial view of an exemplary mobile device holder attached to a prong style belt buckle;

FIGS. 3A through 3C illustrate different types of clips for removably attaching a holder to a belt buckle, in accordance with an embodiment of the present invention. FIG. 3A is a diagrammatic side view of a clamping clip. FIG. 3B is a diagrammatic side view of a top clip, and FIG. 3C is a diagrammatic side view of a back clip; and

FIGS. 4A through 4C illustrate an exemplary mobile device holder attached to a mounting device, in accordance with an embodiment of the present invention. FIG. 4A is a pictorial side view of the mounting device. FIG. 4B is a pictorial view the mobile device holder and mounting device. FIG. 4C is a pictorial side view of the mobile device holder attached to the mounting device.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settle law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). The ordinary meaning of “substantially halfway” is thus reasonably close to or nearly at the midpoint between the forwardmost point of the upper or outsole and the rearwardmost point of the upper or outsole.

Similarly, the term “substantially” is well recognized in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform’. The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of Claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit —“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. §112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to avoid a strict numerical boundary to the specified parameter,” see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” includes the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, are generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of, or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “A memory controller comprising a system cache . . . ” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” limits the scope of a claim to the specified elements or method steps, plus those that do not materially affect the basis and novel characteristic(s) of the claimed subject matter. Moreover, for any claim of the present invention which claims an embodiment “consisting essentially of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the presently disclosed and claimed subject matter may include the use of either of the other two terms. Thus in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

An embodiment of the present invention may provide a mobile phone holder that may be attached to the top portion of a frame and prong style belt buckle. In some embodiments, the holder may be attached to the top horizontal member of the frame of the buckle, which may act as a pivot point for the holder. It is believed that this configuration may enable a user to tilt the phone up for easy use of the phone and of the buckle. Some embodiments may enable information to be broadcast through the phone screen or speakers. Some embodiments may also enable the phone to be inserted into the holder with the screen towards the user's body for privacy. Throughout this description, embodiments of the present invention may be referred to as a phone holder or a mobile phone holder. Nevertheless, it is contemplated that some of these embodiments may be configured for use with a multiplicity of suitable mobile devices including, without limitation, digital music players, digital tablets, personal digital assistants, etc. Therefore, when an embodiment is referred to as a phone holder or a mobile phone holder herein, it may be understood that the embodiment may also be implemented as a holder for various different types of mobile devices.

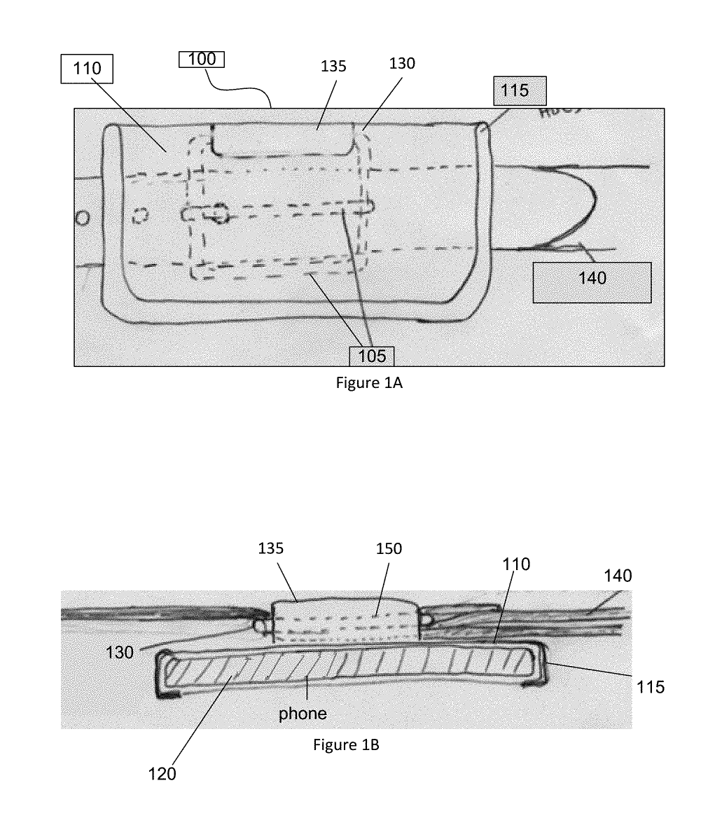

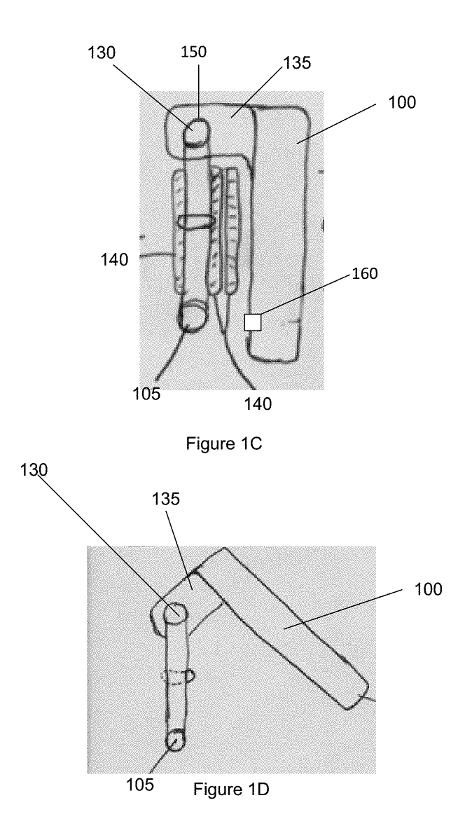

FIGS. 1A through 1D illustrate an exemplary mobile device holder 100 attached to a frame and prong style belt buckle 105, in accordance with an embodiment of the present invention. FIG. 1A is a diagrammatic front view. FIG. 1B is a diagrammatic top view. FIG. 1C is a diagrammatic side view, and FIG. 1D is a diagrammatic side view with holder 100 in a tilted position. Referring to FIGS. 1A and 1B, in the present embodiment holder 100 comprises a back panel 110 and a rim 115 along three edges of holder 100. Rim 115 may be deep enough to typically enable a device 120 to be slid into holder 100 and held in place against back panel 110. It is contemplated that the rim around the holder in some embodiments may be adjustable to fit a range of mobile devices. Attachment member 135 may be connected to a rear portion of holder 100, at an upper portion of the back panel, and may comprise at least an opening 150 through which horizontal member 130 may pass. Opening 150 may include, but not limited to, a slot, an aperture or a hole with an appropriate diameter to typically enable attachment member 135 to pivot around horizontal member 130. In the present embodiment, a mobile device 120 may be held in holder 100 by gravity, as the weight of device 120 may hold device 120 in holder 100. This may typically allow for easy insertion and removal of device 120 into holder 100. Those skilled in the art will readily recognize, in light of and in accordance with the teachings of the present invention, that some embodiments may comprise additional means for securing the device in the holder such as, but not limited to, non-stick inner surfaces, spring loaded clips near the top openings of the rim, a panel that may be slid into place at the top of the holder once the device has been inserted, a hinged panel that may be lifted to enable the device to be placed into the holder and then closed to help hold the device in place, etc. A gap provided by attachment member 135 between a belt buckle and back panel 110 enables a clip to be inserted which can pivot around horizontal member 130. The pivoting arrangement allows a user to operate the structure of which device holder 100 is attached. Furthermore, some alternate embodiments may be configured so that the device is slid into the holder through a side opening rather than a top opening. In yet other alternate embodiments, the device may be mounted to the holder using means other than a rim. For example, without limitation, in some embodiments the device may snap into adjustable or non-adjustable clips on the holder. Some embodiments may comprise a lanyard or retractable clip to retain the device. In other embodiments the surface of the holder may comprise hook and loop material that may correspond to hook and loop material on the device. In yet other embodiments the holder may be adhered to the device using permanent or temporary adhesives. In the present embodiment, device 120 may be placed in holder 100 with the screen facing out to display information or with the screen facing in for privacy. Device 120 may comprise of, but not limited to, mobile phones, portable phones, smart phones, iPhone, portable computers, android phones, etc. A user could glance at the phone to read a text or see who is calling without removing the phone. Attachment member 135 and horizontal member 130 provides a pivot point of device holder 100.

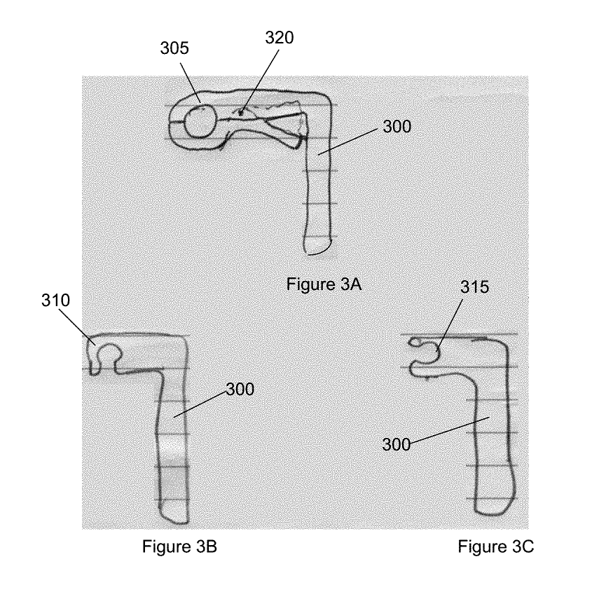

Referring to FIGS. 1C and 1D, in the present embodiment, holder 100 may be permanently attached to an upper horizontal member 130 of belt buckle 105 by an attachment member 135. Attachment member 135 may be connected to a rear portion of holder 100 and may comprise at least one of a slot, an aperture, an opening or a hole 150 through which horizontal member 130 may pass. This slot, aperture, opening or hole 150 may be of an appropriate diameter to typically enable attachment member 135 to pivot around horizontal member 130. This pivoting may enable a user to use some aspects of device 120 while still in holder 100. For example, without limitation, the user may be able to pivot up holder 100 to glance at device 120 to read a text or see who is calling without removing device 120 from holder 100. This pivoting also may enable the user to operate belt buckle 105 even with holder 100 attached by typically allowing holder 100 to pivot up to give the user access to buckle 105 and an attached belt 140. In addition, the pivoting may also help keep device 120 in holder 100. The weight of the phone may help to hold holder 100 in a vertical position snug to buckle 105 when a wearer is standing and may enable holder 100 to pivot when the wearer is bending, which may help keep device 120 in holder 100 and may make holder 100 more comfortable when sitting. An additional embodiment may comprise a Velcro, clip or magnet 160 near the lower portion of the back of the holder that may engage with the lower horizontal member of the buckle to hold the holder flat against the buckle even when the wearer bends forward. In the present embodiment, attachment member 135 along with holder 100 may be permanently attached to buckle 105, and this assembly of buckle 105 and holder 100 may be made available to end users as a single product. Alternatively, holder 100 may be provided to an end user to be permanently attached to a buckle 105 of his own choosing. It is contemplated that in other embodiments the holder may be removably attached, for example, without limitation, by a variety of clips as illustrated by way of example in FIGS. 3A through 3C or other attachment means. In the present embodiment, attachment member 135 may extend far enough from buckle 105 to typically enable buckle 105 and a belt 140 to fit behind holder 105 while still allowing holder 100 to maintain a substantially vertical position. It is contemplated that holder 100 may be made of a multiplicity of suitable materials including, without limitation, wood, composite materials, various plastics, reinforced plastic, elastomer materials, a mix of these materials, glass, laminated veneer, various metals, etc. Buckle 100 may typically be constructed from metal. However, various different materials may be used in some alternate embodiments such as, but not limited to, plastic or composite materials.

In typical use of the present embodiment, holder 100 may be attached to top horizontal member 130 of buckle 105 with pivoting attachment member 135. It is believed that many assume incorrectly that horizontal member 130 acts to secure belt 140 in some way. Typically, the vertical members and the prong of buckle 105 hold the belt in place. When a user wishes to store device 120, device 120 may be slid into holder 100. The top loading configuration of holder 100 may allow for quick and easy access to device 120. The pivoting attachment configuration may enable a user to tilt device 120 up for use, as illustrated by way of example in FIG. 1D. This position typically allows many functions of device 120 to be used while in holder 100 such as, but not limited to, texting, viewing the screen of device 120, pressing buttons or a touch screen to perform functions including, without limitation, rejecting or answering calls, taking pictures, adjusting volume, etc. When the user wishes to access device 120, the user can typically easily access device 120 and may slide device 120 from holder 100 quickly instead of having to fumble to find device 120 in a pocket, purse, while driving, etc. If desired, the user may also broadcast to other nearby individuals any information such as, but not limited to, video, pictures, or music on the screen or coming from the speakers of device 120 while device 120 is in holder 100 since holder 100 holds device 120 prominently on the front of the user. This broadcasting may be accomplished in a hands free way. Similarly, the user to record video hands free while device 120 is in holder 100. If the user wishes to keep device 120 private, device 120 may be placed in holder 100 with the screen facing inward. It is contemplated that holder 100 may also be seen as a way of protecting belt buckle 105 from unwanted use. In some applications, device 120 may be removed from holder 100 so that holder 100 may be used for another purpose for example, without limitation, marching with a flag, bottle opener or bracing a fishing pole. In some applications holder 100 may be used to hold items other than a phone including, without limitation, tablet computers, digital music players, cameras, credit cards, money, calculators, ID badge, two-way radio, cigarettes, epi pen, car keys, laser tag detector, etc.

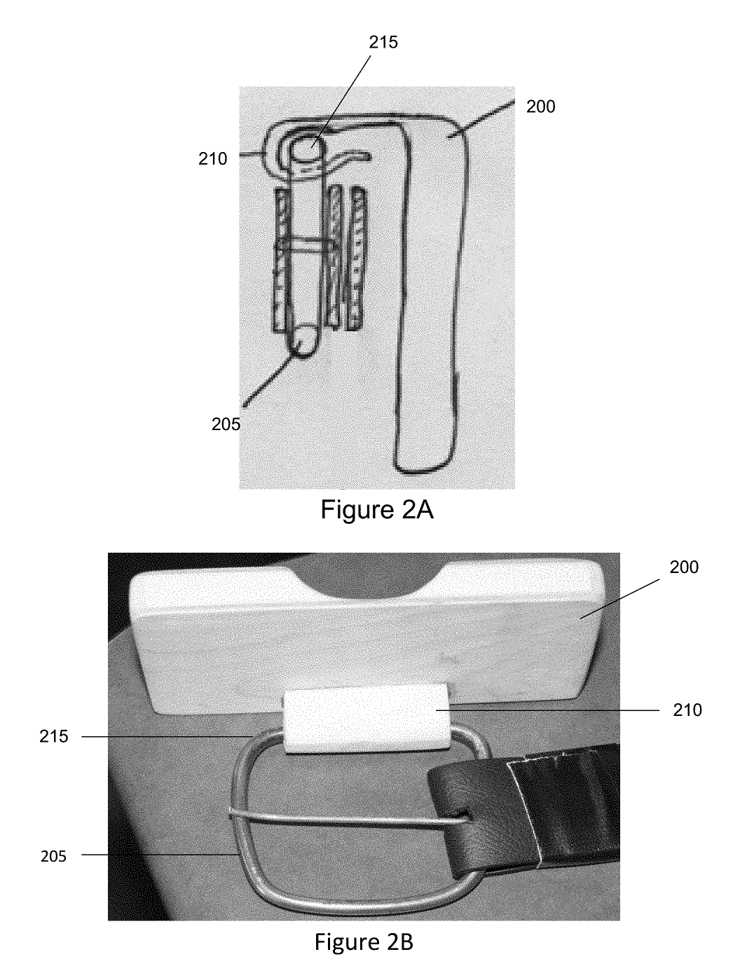

FIG. 2A is a diagrammatic side view of an exemplary mobile device holder attached to a frame and prong style belt buckle by a removable clip, in accordance with an embodiment of the present invention. FIG. 2B is a pictorial view of an exemplary mobile device holder attached to a prong style belt buckle. FIGS. 2A and 2B show an exemplary mobile device holder 200 attached to a frame and prong style belt buckle 205 by a removable clip 210, in accordance with an embodiment of the present invention. In the present embodiment, holder 200 may be clipped onto a top horizontal member 215 of buckle 205 with clip 210. Clip 210 may be able to pivot around horizontal member 215 to enable holder 200 to be tilted upward so that a device may be used while in holder 200 and to provide access to buckle 205. Clip 210 may be sized to be functional with a wide variety of belt buckles. In the present embodiment clip 210 and holder 200 may be made of rigid materials such as, but not limited to, rigid plastic, wood, or metal to typically provide a rigid and sturdy feel while pivoting holder 200. Clip 210 may also enable holder 200 to be slid off of buckle 205 and placed on other buckles. It is contemplated that the present embodiment along with other clip versions may enable holder 200 to detach from buckle 205 during an emergency high load situation. This could be seen as a safety feature. In embodiments that are permanently attached, such as, but not limited to, the embodiment illustrated by way of example in FIGS. 1A through 1D, a portion of the attachment member may be configured to break off under extreme loading to provide a similar safety feature. FIG. 2B is a pictorial view of an exemplary mobile device holder attached to a prong style belt buckle.

FIGS. 3A through 3C illustrate different types of clips for removably attaching a holder 300 to a belt buckle, in accordance with an embodiment of the present invention. FIG. 3A is a diagrammatic side view of a clamping clip 305. FIG. 3B is a diagrammatic side view of a top clip 310, and FIG. 3C is a diagrammatic side view of a back clip 315. Referring to FIG. 3A, clamping clip 305 comprises two components are mated with a spring loaded pivot point 320 which pushes a clamping portion of clip 305 together and an actuating portion of the components apart. Clamping clip 305 may function similarly to a clothespin wherein a user may squeeze the actuating portion of clip 305 to open the clamping portion of clip 305. Once clip 305 is in place around the appropriate portion of a buckle, the user may release the actuating portion of clip 305 to close the clamping portion of clip 305 around the buckle. The clamping portion of clip 305 remains loose enough to enable clip 305 to pivot around the buckle to typically enable holder 300 to be moved into a position where a device within holder 300 may be used.

Referring to FIG. 3B top clip 310 comprises a downward facing notch that may be clipped onto the appropriate portion of a buckle from the top of the buckle. Referring to FIG. 3C, back clip 315 comprises a rearward facing notch that may be clipped onto the appropriate portion of a buckle from the back of holder 300. It is contemplated that back clip 315 and top clip 310 may be made of a multiplicity of suitable materials that may allow for some portion of the clip to flex such as, but not limited to, various plastics, rubber, composite material, etc. The notches in top clip 310 and back clip 315 may be sized to enable holder 300 to pivot around the buckle to which clips 310 and 315 are attached.

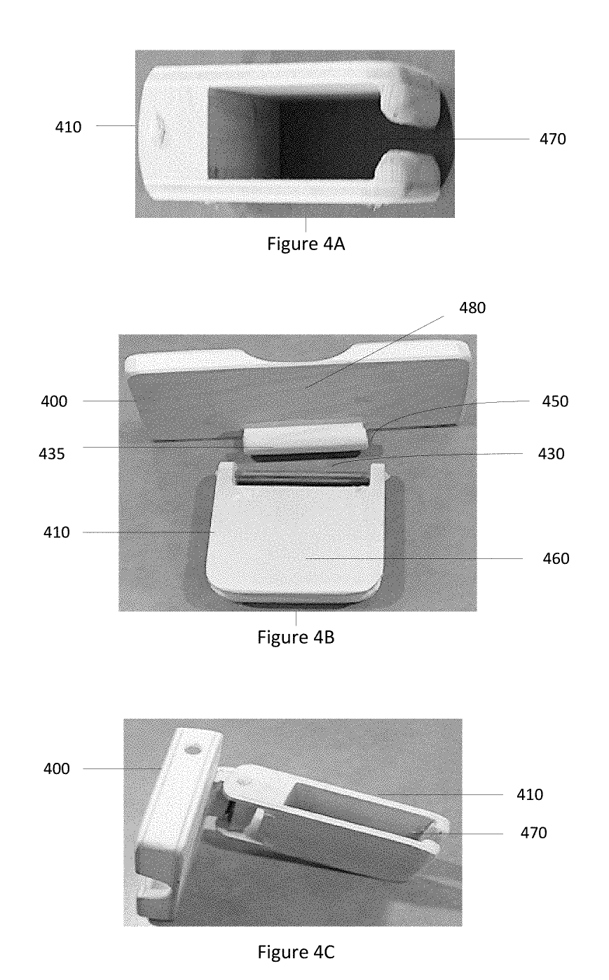

FIGS. 4A through 4C illustrate an exemplary mobile device holder 400 attached to a mounting device 410, in accordance with an embodiment of the present invention. FIG. 4A is a pictorial side view of the mounting device 410. FIG. 4B is a pictorial view the mobile device holder 400 detached from the mounting device 410. FIG. 4C is a pictorial side view of the mobile device holder 400 attached to the mounting device 410. Referring to FIG. 4A, mounting device 410 is shown in a side view, in which the mounting device 410 comprises a downward facing slot 470 that may be slid and clipped onto any appropriate portion of a belt. Referring to FIG. 4B, mounting device 410 is shown detached from mobile device holder 400. Mounting device 410 is shown in a frontal view comprising a horizontal member 430. Mobile device holder 400 is shown in a tilted position comprising an attachment member 435 and slot 450. Slot 450 may be slid to attach mounting device 410 to any portion of a belt. Referring to FIG. 4C, a side view of the mobile device holder 400 attached to the mounting device 410 is shown.

In the present embodiment, attachment member 435 may be connected to a rear portion of holder 400 and may comprise at least an opening 450 through which horizontal member 430 may pass. Opening 450 may comprise of an aperture or hole of an appropriate diameter to typically enable attachment member 435 to pivot around horizontal member 430. This pivoting may enable a user to use some aspects of device 120 (FIG. 1B) while still in holder 400. For example, without limitation, the user may be able to pivot up holder 400 to glance at a screen display of the device 120 to show and read a text or see who is calling without removing device 120 from holder 400. This pivoting also may enable the user to operate belt buckle 105 even with holder 400 attached by typically allowing holder 400 to pivot up to give the user access to buckle 105 and an attached belt 140. In addition, the pivoting may also help keep device 120 in holder 400. The weight of the phone may help to hold holder 400 in a vertical position snug to buckle 105 when a wearer is standing and may enable holder 400 to pivot when the wearer is bending, which may help keep device 120 in holder 400 and may make holder 400 more comfortable when sitting. An additional embodiment may comprise a Velcro, clip or magnet 460 near the lower portion of the back of the holder 400 that may engage with the Velcro, clip or magnet 480 near the lower portion of the mounting device 410 to hold the holder 400 against the mounting device 410. In the present embodiment, attachment member 435 along with holder 400 may be permanently attached to mounting device 410, and this assembly of mounting device 410 and holder 400 may be made available to end users as a single product. Alternatively, holder 400 may be provided to an end user to be permanently attached to a belt of his own choosing. It is contemplated that in other embodiments, the holder may be removably attached, for example, without limitation, by a variety of clips as illustrated by way of example in FIGS. 3A through 3C or other attachment means. In a general use of the present embodiment, slot 470 may generally be slid at an appropriate portion of a belt to attach mounting device 410 to the belt, while still allowing holder 400 to maintain a substantially vertical position. It is contemplated that holder 400 may be made of a multiplicity of suitable materials including, without limitation, wood, composite materials, various plastics, reinforced plastic, elastomeric materials, a mix of these materials, glass, laminated veneer, various metals, etc. Horizontal member 430 may typically be constructed from metal. However, various different materials may be used in some alternate embodiments such as, but not limited to, plastic or composite materials. In an alternative use of the present embodiment, device holder 400 may be detached from the mounting device 410. Device holder 400 may then be directly attached to top horizontal member 130 of buckle 105 (see FIGS. 1A-1D) with pivoting attachment member 435.

Those skilled in the art will readily recognize, in light of and in accordance with the teachings of the present invention, that a multiplicity of suitable means may be used to attach a holder to a buckle including, without limitation, rigid clips, clothespin styles clip, friction fit clips, magnetic clips, attachment members that may be assembled around the buckle with screws, pins, or other fasteners, rigid clips in which two pieces may be bolted together, etc. In one embodiment a clip may be implemented in which a portion of the clip may be rotated to lock the buckle in place and the same portion may be rotated in order to release the buckle. In other embodiments, the clips or attachment members may comprise bearings or non-stick coatings which may facilitate the pivoting motion of the holder around the buckle. Yet other embodiments may comprise straps made of a flexible material such as, but not limited to, silicone or elastic that may be wrapped around the buckle to mount the holder to the buckle.

It is contemplated that some embodiments may be implemented to be attached to the bottom horizontal member of a frame and prong buckle rather than the top horizontal member. In these embodiments the attachment means may be permanent or removable. Some of these embodiments may also comprise a magnet, clasp or hook and loop material that may hold the upper portion of the holder in place at the top of the buckle. Other of these embodiments may be configured to hang downward from the bottom horizontal member of the buckle. Some embodiments may comprise means for attaching holders to buckles other than frame and prong style buckles such as, but not limited to, tang buckles, double D-ring buckles, heel bar buckles, etc.

Those skilled in the art will readily recognize, in light of and in accordance with the teachings of the present invention, that various different features may be included in some embodiments. For example, without limitation, a belt clip may be provided to which a holder may be clipped or otherwise attached. This may enable the holder to be placed anywhere on a belt, not only on the buckle. This belt clip may comprise a horizontal member similar in diameter and size as the horizontal member of the belt buckle and a clip or frame into which a belt may be inserted. Other embodiments may comprise flashlights, leashes that may connect the device to the buckle for added security, shock absorbing materials, external speakers that may connect to the device for enhanced broadcasting of sound, etc.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing a mobile device holder that may be mounted to a buckle according to the present invention will be apparent to those skilled in the art. Various aspects of the invention have been described above by way of illustration, and the specific embodiments disclosed are not intended to limit the invention to the particular forms disclosed. The particular implementation of the mobile device holder may vary depending upon the particular context or application. By way of example, and not limitation, the mobile device holders described in the foregoing were principally directed to belt buckle mounted implementations; however, similar techniques may instead be applied to buckles on various different items such as, but not limited to, suspenders, handbags, briefcases, or luggage, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus comprising:
a device holder being configured to attach to a horizontal member, wherein said device holder comprises:
a back panel:
a rim, said rim being configured to fit the device and held against the back panel; and
an attachment member connected to a rear portion of said device holder, said attachment member comprising an opening through which the horizontal member may pass, and wherein said opening is operable to enable said device holder to pivot around the horizontal member.

2. The apparatus of claim 1, wherein said device holder is configured to pivot around said horizontal member without removing the device from said device holder.

3. The apparatus of claim 2, in which the device held in said device holder comprises at least a mobile phone, wherein said device holder is configured to pivot the mobile phone around the horizontal member to read a text or see who is calling without removing the mobile phone from said device holder.

4. The apparatus of claim 1, wherein the horizontal member comprises an upper portion of a belt buckle.

5. The apparatus of claim 4, and in which said device holder further comprises at least one of a Velcro, a clip and a magnet to hold said device holder flat against the belt buckle.

6. The apparatus of claim 1, in which said device holder is made of at least a wood.

7. The apparatus of claim 1, in which said device holder is made of at least one of a composite material, a plastic, an elastomeric material, a laminated veneer, and a metal.

8. The apparatus of claim 1, in which said attachment member further comprises a clamping clip having at least a mating component mated with a spring loaded pivot point which pushes a clamping portion of said clamping clip, said mating component comprising an actuating portion to create said opening through which the horizontal member may pass.

9. The apparatus of claim 1, further comprising a mounting device, in which an upper portion of a mounting device comprises the horizontal member, and wherein said device holder is configured to pivot around said horizontal member without removing the device from said holder.

10. The apparatus of claim 9, in which said device holder and mounting device is made of at least one of a wood, a composite material, a plastic, and an elastomer material.

11. The apparatus of claim 9, in which said mounting device comprises at least a downward facing slot.

12. The apparatus of claim 11, in which said downward facing slot is configured to be slid and clipped onto a portion of a belt, to attach the device holder to the belt.

13. The apparatus of claim 11, in which said device holder further comprises at least one of a Velcro, a clip and a magnet to hold said device holder flat against said mounting device.

14. The apparatus of claim 12, in which said device holder is detachable from said mounting device.

15. The apparatus of claim 14, in which said device holder is operable to be attached to a top horizontal member of a buckle of said belt.

16. An apparatus comprising:
a device holder being configured to holster a mobile device, wherein said device holder comprises:
a back panel:
a rim, said rim being configured to fit the device and held against the back panel; and
an attachment member connected to a rear portion of said holder, said attachment member comprising an opening through which the horizontal member may pass, and wherein said opening is operable to enable said device holder to pivot around the horizontal member; and
a mounting device, in which said device holder is configured to pivot around a horizontal member of said mounting device without removing the device from said device holder, and wherein said mounting device comprises at least a downward facing slot configured to be slid and clipped onto a portion of a belt, to attach the device holder to the belt.

17. The apparatus of claim 16, in which said device holder is detachable from said mounting device, and wherein said device holder is operable to be directly attached to a top horizontal member of a belt buckle.

18. An apparatus comprising:
means for holding a device, wherein said device holding means comprises:
means for holding the device against a back panel;
means for attaching the device holding means to a horizontal member; and
means for pivoting said device holding means around the horizontal member;

19. The apparatus of claim 18, further comprising means for mounting said device holding means to a belt structure.

20. The apparatus of claim 19, wherein said device holding means is detachable from said device mounting means, and wherein said device holding means is operable to be directly attached to a top horizontal member of a belt buckle.
